(19) United States
(12) Patent Application Publication
(10) Pub. No.: US 2008/0040331 A1
(43) Pub. Date: Feb. 14, 2008

(54) COMPUTER-IMPLEMENTED SOCIAL SEARCHING

(75) Inventors: Patrick Hanna, Lexington-Fayette, KY (US); Steve Mansfield, Lexington, KY (US)

Correspondence Address: VENABLE LLP, P.O. BOX 34385, WASHINGTON, DC, 20043-9998, US

(73) Assignee: IIor, LLC, Lexington, KY (US)

(21) Appl. No.: 11/780,543

(22) Filed: Jul. 20, 2007

Related U.S. Application Data
(60) Provisional application No. 60/832,155, filed on Jul. 21, 2006.

(51) Int. Cl. G06F 17/30

(52) U.S. Cl. 707/3; 707/E17.108

(57) ABSTRACT

A computer-implemented method of searching comprises: accepting user input regarding a social profile of the user, wherein the social profile includes at least two factors; displaying a graphical user interface (GUI) adapted to receive a user selection indicative of which of the at least two social profile factors to use to modify a search request; accepting a search request from the user; modifying the search request according to the user selection; and submitting the modified search request to a search engine.

### BACKGROUND OF THE INVENTION

1. Field of the Invention

Embodiments of the present invention relate to search engines, and more particularly to social or community searches.

2. Related Art

Social search is a concept within the internet search community which has received a lot of attention lately. On a broad level, social searching involves using the internet community to help improve the relevance of search results. Many ideas have been proposed for accomplishing this but most fall short for one reason or another. One problem is that people do different types of searches at different times. If an avid comic book reader is searching for information about the latest Batman series, then the results would be enhanced by knowing that he is a comic book reader. However if the same comic book reader is instead looking for advice on how to fix a leaky faucet, providing results slanted toward comics would be undesirable. A user's age may also be an appropriate factor to consider when searching for information on medical problems or vacation destinations, but not when searching for instructions on hooking up a television's surround sound speakers.

### BRIEF SUMMARY OF THE INVENTION

In an exemplary embodiment, the invention may be a computer-implemented method of searching, comprising: accepting user input regarding a social profile of the user, wherein the social profile includes at least two factors; displaying a graphical user interface (GUI) adapted to receive a user selection indicative of which of the at least two social profile factors to use to modify a search request; accepting a search request from the user; modifying the search request according to the user selection; and submitting the modified search request to a search engine.

### BRIEF DESCRIPTION OF THE DRAWINGS

The foregoing and other features and advantages of the invention will be apparent from the following, more particular description of exemplary embodiments of the invention, as illustrated in the accompanying drawings. In the drawings, like reference numbers generally indicate identical, functionally similar, and/or structurally similar elements. The drawing in which an element first appears is indicated by the leftmost digits in the corresponding reference number. An exemplary embodiment is discussed below in the detailed description of the following drawings:

FIG. 1 is an exemplary embodiment of a search equalizer graphical user interface panel;

FIG. 2 is a flowchart of an exemplary embodiment of a search process according to embodiments of the present invention; and

FIG. 3 a block diagram illustrating the computing context of the invention.

### DETAILED DESCRIPTION OF THE INVENTION

Exemplary embodiments of the present invention is now described with reference to the figures, where like reference numbers indicate identical or functionally similar elements. While specific configurations and arrangements are discussed, it should be understood that this is done for illustrative purposes only. A person skilled in the relevant art will recognize that other configurations and arrangements can be used without departing from the spirit and scope of the invention. It will also be apparent to a person skilled in the relevant art that this invention can also be employed in a variety of other systems and applications. All examples herein are exemplary and non-limiting.

Exemplary embodiments of the present invention provide an approach to “Social Search” which combines a number of user selectable elements in order to provide a wide range of possibilities for enhancing user relevance without the restrictions inherent in the currently employed methods.

Exemplary embodiments of the invention combine two factors to make “Social Search” a viable enhancement over what is currently available. These factors include User Supplied results and the use of a searcher's “Social Profile” in ordering the results to move the most relevant results to the top of the list.

User Supplied results are known in the art. These are items which have been found and “tagged” (categorized by content) by other searchers. Users then submit these “tagged” items to a service that stores them in a database and provides a search interface so that other users can access the information in an organized fashion. There are many examples of this sort of service currently on the internet, including, e.g. Delicious (http://del.icio.us/), www.PreFound.com, and www.Furl.net. The advantage of these services is that they tend to eliminate much of the spam or junk results that are returned by the general search engines (e.g., Google, Yahoo!) and over time will include a good list of human reviewed sites about a given topic. The User Supplied results will always lag somewhat behind the general search sites due to the time it takes for human contributors to find and tag sites so they need to be supplied in combination with results from a general (analytical) search engine.

Exemplary embodiments of the present invention add the use of a social profile and a Search Equalizer Panel to the conventional social search. This panel allows the searcher to select how much or how little he wants his “social profile” to be included in the generation of his search results. The searcher can use the panel indicators to decide which segments of his “social profile” that he wants to include when searching on the internet. The “social profile” may consist of demographic data such as, but not limited to, age, marital status, family makeup, and locale, as well as descriptors of particular interests that the user might have. Examples of these interest descriptors might be Archery, Camping, Childhood education, or Physics.

The “social profile” information may be broken into different types of data. First, for example, demographic data, e.g. age, marital status, sex. These items may be used to separate the searchers into communities. A community may be able to rank results after they are displayed so that they decide which search results are more relevant to them. The idea here is that people in the same “age and stage” will find similar things relevant and will therefore benefit from the ratings of other people within their community. This type of community ranking of results is currently being provided by the Eurekster company through their Swicki search engine technology.

Another type of data that may be used is geographic data, e.g. zip code, city/state, etc. These data may be used to provide localized results to the searcher. For example, a search for “pizza” would return restaurants within a given mile radius of the searcher's designated location. This type of localized search is available today on many of the commercial search sites.

Another type of data that may be used is interest data, e.g. archery, camping, childhood education, etc. The user may select one or more area of interests, and select keywords relating to each area of interest. These data may be used to weight the search results toward these interests. This may be done, for example, by adding a predefined set of keywords to the search terms that the searcher submitted so that the results would be targeted around that interest group. For example, if the searcher had camping as an interest and searched on “knife”, keywords like “camping or outdoors” would be added to his search term to be sure that knives which would be used for camping and outdoor purposes would be listed before kitchen or household knives.

Embodiments of the invention use the fact that the user is the only one who knows when his demographic, geographic, or interest information will be helpful on a given search. The Search Equalizer Panel is provided to allow the user to select when to take this extra information into account when performing a search.

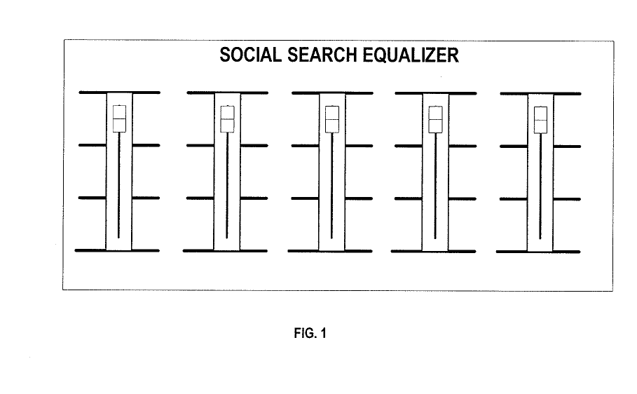

FIG. 1 shows an exemplary embodiment of graphical user interface (GUI) of a search equalizer panel (SEP). The SEP may have one or more selectors, for example, one selector for each type of data that makes up the user's social profile. In one embodiment, a selectors may be binary, with the user turning the selector on or off, according to whether that factor should be included in a search. Alternatively, a selector may be scaled, allowing the user to select to which degree the factor contributes to the weighting of search terms. For example, for an interest area, the user may select among multiple positions, e.g., 0-3, to indicate how many key words from that interest area should be included in the search. The SEP may be present as a separate window on a user's computer display, and may provide the ability to save the user's current settings.

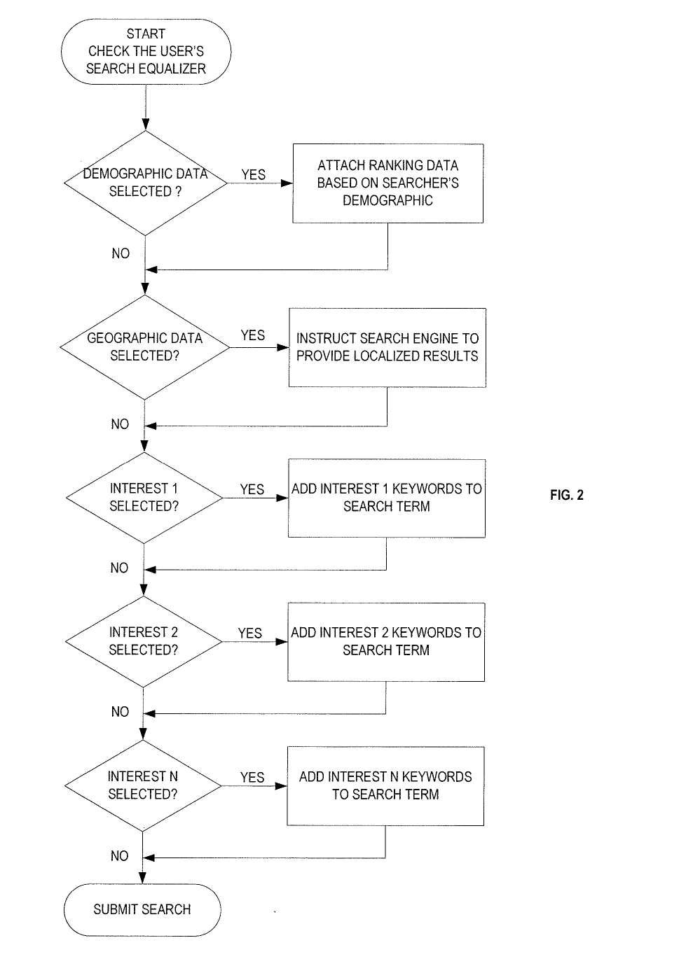

FIG. 2 shows a flowchart of an exemplary search process according to an embodiment of the present invention. The user has already selected settings within the SEP and saved the settings. When the user initiates a search on the internet, either through a commercial internet search engine (e.g. Yahoo!, or Google) or through a separate search engine, prior to beginning the search, the user's SEP is checked. If the user has selected to include demographic data, ranking data based on the user's demographic will be attached to the search request. If the user has geographic data selected, the search engine will be instructed to return localized results, for example, the user's Zip code may be appended to the search request. The user's interest area selectors are checked, and the number of keywords selected for each interest area are added to the search request. The format of the search request may be dependent on the search engine being used. The search request may be modified, for example, by appending keywords with logic connectors such as AND, OR, and NOT, or by other search request formats known in the art. Then the search is submitted to the search engine, which conducts the search and returns any relevant results to the user.

Some examples of the use of the social profile and SEP follow. In one scenario, a searcher is looking for an Italian restaurant for a special dinner. The searcher would select to turn on his demographic information so that he would find restaurants which were highly ranked by other people in a similar “age and stage”. He would also select to turn on his geographic information so that he would be shown only restaurants in his local area. He would select to turn off his interest indicators so that his results would not be skewed toward archery and camping.

In another scenario, a searcher is looking for a particular hunting knife. He would select to turn off his demographic information because “age and stage” does not come into play for this search. He would select to turn on geographic information if he wanted a knife that he could pick up locally or off if mail order was an acceptable option. He would select to turn on his interest indicators related to camping or outdoor activities so that his search results would be skewed toward the type of knife that he was interested in.

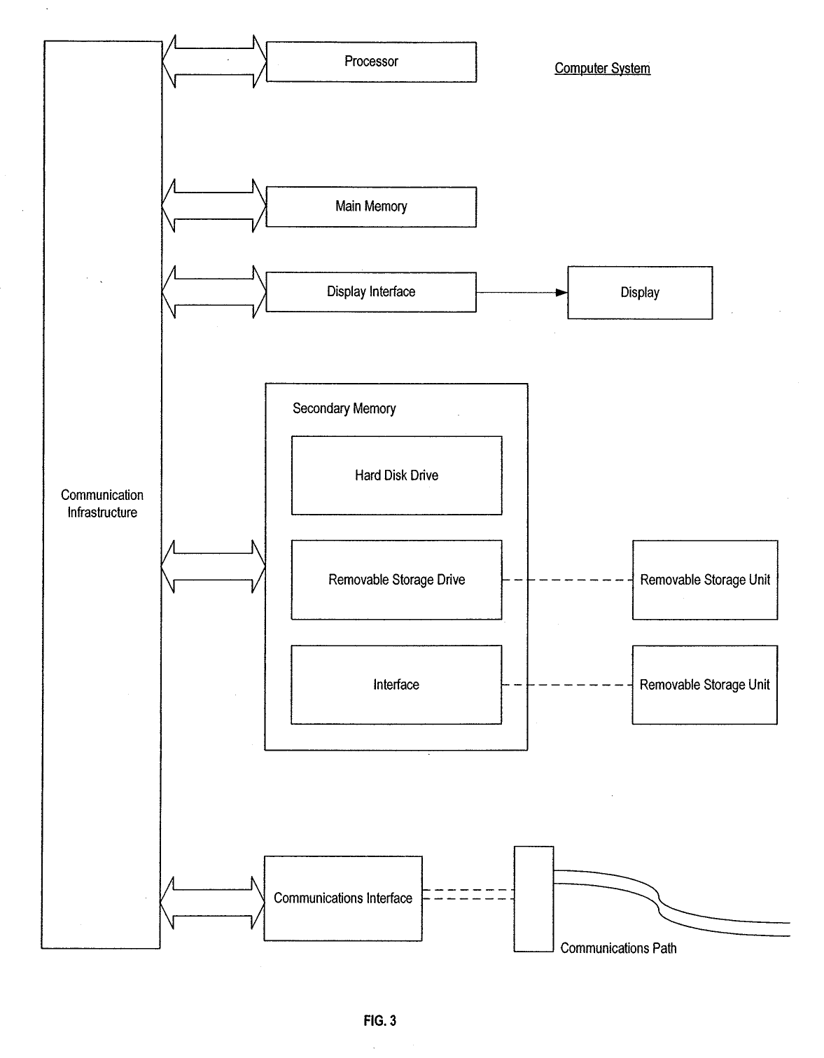

An exemplary computer environment for implementation of embodiments of the present invention is described with respect to FIG. 3. The present invention may be implemented using hardware, software or a combination thereof and may be implemented in one or more computer systems or other processing systems. In one embodiment, the invention may comprise one or more computer systems capable of carrying out the functionality described herein. The exemplary computer system shown in FIG. 3 may include one or more processors. The processor may be connected to a communication infrastructure (e.g., a communications bus or network). Various software embodiments are described in terms of this exemplary computer system. After reading this description, it will become apparent to a person skilled in the relevant art(s) how to implement the invention using other computer systems and/or computer architectures.

The computer system may include a display interface that may forward graphics, text, and other data from the communication infrastructure (or from a frame buffer not shown) for display on the display unit.

The computer system may also include a main memory, preferably random access memory (RAM), and may also include a secondary memory. The secondary memory may include, for example, a hard disk drive and/or a removable storage drive, representing a floppy disk drive, a magnetic tape drive, an optical disk drive, etc, but which is not limited thereto. The removable storage drive may read from and/or write to a removable storage unit in a well known manner. The removable storage unit may represent a floppy disk, magnetic tape, optical disk, etc. which may be read by and written to by the removable storage drive. As will be appreciated, the removable storage unit may include a computer usable storage medium having stored therein computer software and/or data.

In alternative embodiments, the secondary memory may include other similar means for allowing computer programs or other instructions to be loaded into the computer system. Such means may include, for example, a removable storage unit and an interface. Examples of such may include, but are not limited to, a removable memory chip (such as an EPROM, or PROM) and associated socket, and/or other removable storage units and interfaces that may allow software and data to be transferred from the removable storage unit to the computer system.

The computer system may also include a communications interface. The communications interface may allow software and data to be transferred between the computer system and external devices. Examples of the communications interface may include, but are not limited to, a modem, a network interface (such as an Ethernet card), a communications port, a PCMCIA slot and card, etc. Software and data transferred via the communications interface are in the form of signals which may be, for example, electronic, electromagnetic, optical or other signals capable of being received by communications interface. These signals may be provided to the communications interface via a communications path (i.e., channel). This channel may carry signals and may be implemented using wire or cable, fiber optics, a phone line, a cellular phone link, an RF link and/or other communications channels.

In this document, the terms “computer program medium” and “computer usable medium” are used to generally refer to media such as, but not limited to, removable storage drive, a hard disk installed in hard disk drive, and signals. These computer program media are means for providing software to the computer system.

Computer programs (also called computer control logic) may be stored in main memory and/or secondary memory. Computer programs may also be received via the communications interface. Such computer programs, when executed, enable the computer system to perform the features of the present invention as discussed herein. In particular, the computer programs, when executed, may enable the processor to perform the present invention in accordance with the above-described embodiments. Accordingly, such computer programs represent controllers of the computer system.

In an embodiment where the invention is implemented using software, the software may be stored in a computer program product and loaded into the computer system using, for example, a removable storage drive, hard drive or communications interface. The control logic (software), when executed by the processor, causes the processor to perform the functions of the invention as described herein.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A computer-implemented method of searching, comprising:
accepting user input regarding a social profile of said user, wherein said social profile includes at least two factors;
displaying a graphical user interface (GUI) adapted to receive a user selection indicative of which of said at least two social profile factors to use to modify a search request;
accepting a search request from said user;
modifying said search request according to said user selection; and
submitting said modified search request to a search engine.

2. The method of claim 1, wherein said accepting user input regarding a social profile of said user includes accepting input regarding at least two of: demographic information, locality information, and/or at least one interest area information.

3. The method of claim 2, wherein said modifying said search request includes adding to said search request, according to said user selection, at least one of: demographic data, locality data, and/or at least one interest area key word.

4. The method of claim 1, wherein said GUI includes a binary selection for at least one of said at least two social profile factors.

5. The method of claim 1, wherein said GUI includes a non-binary selection for at least one of said at least two social profile factors.
